(19) United States
(12) Patent Application Publication
(10) Pub. No.: US 2005/0120113 A1
(43) Pub. Date: Jun. 2, 2005

(54) System and method for monitoring application utilization

(75) Inventors: Clinton D. Bunch, Sunnyvale, TX (US); Daniel C. Zimmerman, Lancaster, TX (US)

Correspondence Address: SCOTT T. GRIGGS, 1717 main street, suite 3400, Dallas, TX, 75201, US

(73) Assignee: Accountability International, Inc.

(21) Appl. No.: 11/020,814

(22) Filed: Dec. 22, 2004

Related U.S. Application Data
(63) Continuation-in-part of application No. 10/870,469, filed on Jun. 17, 2004.
Application No. 10/870,469 is a continuation of application No. 09/605,124, filed on Jun. 28, 2000, now Pat. No. 6,795,856.

(51) Int. Cl. G06F 15/173

(52) U.S. Cl. 709/224; 709/225

(57) ABSTRACT

A system and method for monitoring application utilization are disclosed. In one embodiment, the system includes a computer having a plurality of applications installed thereon. A monitoring module is associated with the computer in order to monitor a plurality of utilization parametrics to determine the utilization of the applications by a user and provide to the user a substantially realtime, visible indication of the utilization of the applications. Based on data relative to the utilization parametrics, the application may be evaluated in a resource evaluation report. Additionally, based on the data, reports regarding the user's profile and productivity may be developed.

### CROSS REFERENCE TO RELATED APPLICATIONS

This application is a continuation-in-part of co-pending application Ser. No. 10/870,469, entitled “System and Method for Monitoring Access to a Network by a Computer” and filed on Jun. 17, 2004 in the name of Clinton D. Bunch; which is a continuation of application Ser. No. 09/605,124, now U.S. Pat. No. 6,795,856, entitled “System and Method for Monitoring the Internet Access of a Computer” and filed on Jun. 28, 2000 in the name of Clinton D. Bunch; both of which are hereby incorporated by reference for all purposes.

### TECHNICAL FIELD OF THE INVENTION

This invention relates, in general to applications and software programs and, in particular, to a system and method that provide for monitoring the utilization of applications and software programs to enable informed management decisions and resource allocation.

### BACKGROUND OF THE INVENTION

Businesses rely on information technology (IT), including applications, software programs, hardware, and bandwidth, for example, to provide the infrastructure required to support performance and productivity. As IT has become more integrated into business operations and the dependancy on IT has increased, new applications and productivity tools are rapidly being developed and introduced into the marketplace. As a result of the increased offering of IT products, it has become increasingly difficult for businesses and IT professionals to evaluate which combination of existing and new applications and productivity tools are optimum for individual users as well as the business as a whole. In particular, IT professionals do not have the visibility required to understand how the applications and productivity tools are being utilized by the business. Accordingly, a need has arisen for systems and methods that provide visibility into the utilization of IT resources to enable informed management decisions and optimal resource allocation.

### SUMMARY OF THE INVENTION

A system and method are disclosed that provide for monitoring application utilization. In one embodiment, the system includes a computer having a plurality of applications installed thereon. A monitoring module is associated with the computer in order to monitor a plurality of utilization parametrics associated with the plurality of applications. The utilization parametrics are indicative of human interaction and are employed by the monitoring module to provide the user a substantially realtime, visible indication of the utilization of the applications. Based on data relative to the utilization parametrics, the applications may be evaluated in a resource evaluation report. Additionally, based on the data, reports regarding the user's profile and productivity may be generated. The reports and visible indication provide feedback that can modify the behavior of the user. Further, the system and method disclosed herein may be scaled to not only evaluate the utilization of a single user, but to evaluate the utilization of a team of users, group of users, or an entire IT infrastructure.

### BRIEF DESCRIPTION OF THE DRAWINGS

For a more complete understanding of the features and advantages of the present invention, reference is now made to the detailed description of the invention along with the accompanying figures in which corresponding numerals in the different figures refer to corresponding parts and in which:

FIG. 1 is a schematic diagram providing an overview of a network-based IT infrastructure wherein one embodiment of a system for monitoring application utilization is being implemented;

FIG. 2 is a functional block diagram of one embodiment of a computerized device having a monitoring module;

FIG. 3 is a schematic diagram of one operational embodiment of a computer having a monitoring module;

FIG. 4 is a schematic diagram of one embodiment of a processing module generating reports in accordance with the teachings presented herein;

FIG. 5 is a flow chart of one embodiment of a method for monitoring application utilization;

FIG. 6 is a flow chart of another embodiment of a method for monitoring application utilization;

FIG. 7 depicts a schematic diagram of a corporate hierarchy wherein one embodiment of a system for monitoring application utilization is being implemented; and

FIG. 8 depicts a schematic diagram of a user utilizing a computer having one embodiment of a system for monitoring application utilization installed thereon.

### DETAILED DESCRIPTION OF THE INVENTION

While the making and using of various embodiments of the present invention are discussed in detail below, it should be appreciated that the present invention provides many applicable inventive concepts which can be embodied in a wide variety of specific contexts. The specific embodiments discussed herein are merely illustrative of specific ways to make and use the invention, and do not delimit the scope of the present invention.

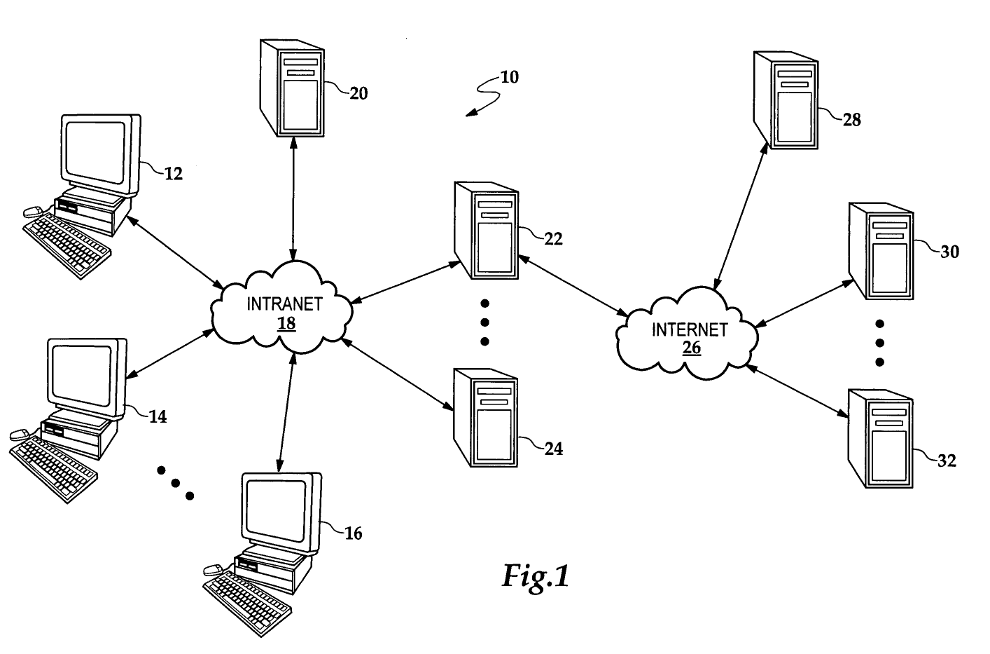

Referring initially to FIG. 1, therein is depicted a network-based IT infrastructure 10 wherein one embodiment of a system for monitoring application utilization is being implemented. Computers 12, 14, and 16 are connected to each other via an intranet 18. Each of the computers 12, 14, and 16 may comprise any combination of hardware, software, and firmware that accepts structured input, processes the input and produces the results of the processing as output. In one embodiment, computers 12, 14, and 16 are personal computers that are designated for a single user or small group of users. In another embodiment, the computers 12, 14, and 16 may comprise personal computers, cellular telephones, personal digital assistants (PDAs), kiosks, televisions, electronic game consoles, MP3 players, or other electronic devices. Additionally, each of the computers 12, 14, and 16 may include any number of peripheral devices such as monitors or keyboards, for example. A router or other device may provide the routing and switching interface for the intranet 18. Each of the computers 12, 14, and 16 may be connected to the intranet 18 by a physical connection, such as a Category 5 (CAT5) cable, or a wireless connection. For example, the wireless connection may be based on an Institute of Electrical and Electronics Engineers (IEEE) 802-based standard such as 802.11, 802.11a, 802.11b (Wi-Fi), or 802.1G, for example.

Servers 20, 22, and 24 are also connected to intranet 18 such that, in one embodiment, computers 12, 14, and 16 and servers 20, 22, and 24 may communicate within a local area network (LAN). The servers 20, 22, and 24 may have a structure and functionality that is similar to the aforementioned computers 12, 14, and 16. In one implementation, the servers 20, 22, and 24 provide services to the computers 12, 14, and 16 via the intranet 18. The servers 20, 22, and 24 may store and administer software applications, data, security measures, or provide access to peripherals or external systems, for example. As illustrated, the server 22 includes a module that provides mail service and access to the Internet 26 for the computers 12, 14, and 16 and the servers 20 and 24. The Internet 26 includes a distributed network of many computers, illustrated as servers 28, 30, and 32, linked together by way of numerous communications providers.

With respect to the computer 12, in operation, an application is installed thereon. A monitoring module having guidelines, which govern the utilization of the application, is also associated with the computer 12. By way of example, the guidelines may prescribe a limit of three hours of Internet browsing with an Internet browser per week. The monitoring module monitors a utilization parametric that is indicative of a user utilizing or interacting with the application. The status of the Internet browser, i.e., inactive or active, may be monitored to determine the time a user consumes on the Internet. By way of another example, the guidelines may prescribe a limit of 5 MB of bandwidth for streaming audio and video content per day. The bandwidth of the content associated with a streaming media application may be monitored to determine the bandwidth a user consumes with respect to streaming content.

The monitoring module may provide visibility into application utilization to a user and/or to an administrator. In one embodiment, the monitoring module may provide an indication to the user of the utilization of the application. The indication may take the form of meter on the desktop that displays the amount of time consumed or time remaining. Accordingly, in this embodiment, the monitoring module provides the user visibility into the application utilization.

In another embodiment, the monitoring module may provide a substantially realtime, visible indication to the user of the utilization of the application. Additionally, in an in-house embodiment, the monitoring module may transfer data relative to the utilization parametric over the intranet 18 to the server 20 which has a processing module installed thereon. The processing module generates, based upon the utilization parametric, a report relative to the utilization of the application. As will be explained in further detail hereinbelow, the report may be a user profile report, a resource evaluation report, or a productivity evaluation report, for example. Accordingly, in this embodiment, the monitoring module provides the user and administrators visibility into the utilization of the application.

In a further embodiment, the monitoring module operates in a stealth mode or benchmark establishing mode wherein no indication is provided to the user regarding the utilization of the application. In this embodiment, the monitoring module, however, does transfer data relative to the utilization parametric over the intranet 18 to the server 20 which has a processing module which may generate one of the aforementioned reports. Hence, in this embodiment, the monitoring module provides administrators visibility into the utilization of the application. It should be appreciated that although the processing module has been described as being installed on the server 20, the processing module may be installed on any computer. For example, in a stand alone embodiment or a single computer environment, the processing module may be installed on computer 16. By way of another example, in an application service provider (ASP) embodiment, the processing module is installed on a remote server, such as server 28, that is accessible via the Internet 26.

Further, it should be appreciated that although an office environment having a particular architecture is depicted in FIG. 1, the system and method for monitoring application utilization may be utilized in any environment having any architecture. For example, the system and method presented herein may be utilized in a home wherein the monitoring module is installed on a home computer that is in communication with a processing module installed on a remote server that is accessible via the Internet.

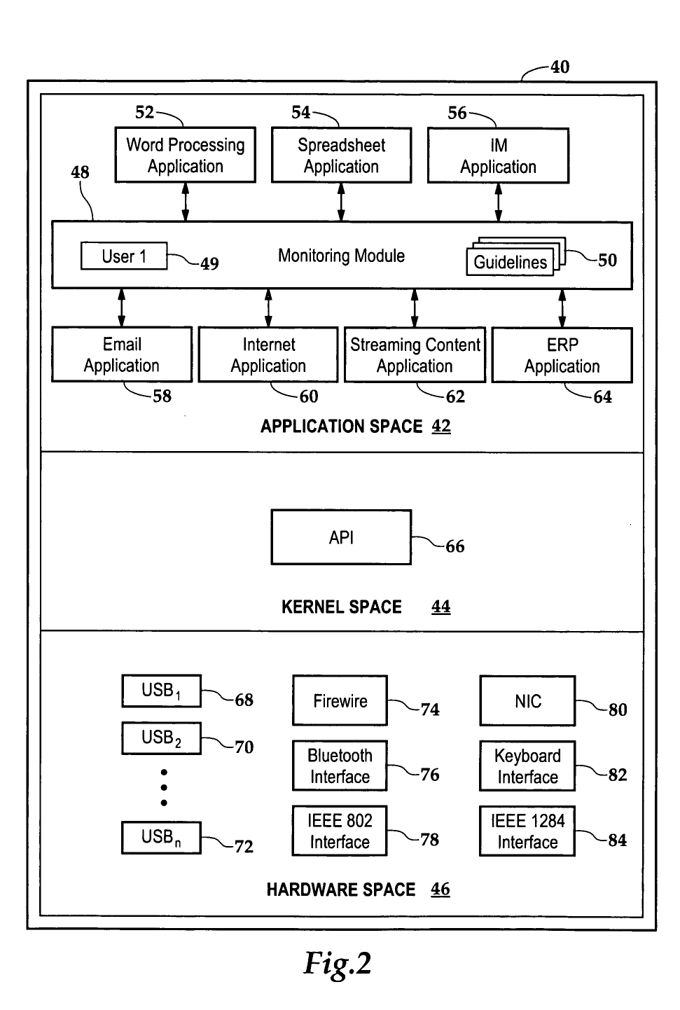

FIG. 2 depicts a functional block diagram of one embodiment of a platform 40, which may be any type of computerized device. The platform 40 includes an application space 42, a kernel space 44, and a hardware space 46. The application space 42 includes a monitoring module 48 having a history log 49 and guidelines 50. Additionally, the application space 42 includes application programs that carry out various useful tasks by accessing the underlying services provided by the kernel space 44. By way of example, the illustrated applications include a word processing application 52, a spreadsheet application 54, an instant messaging (IM) application 56, an email application 58, an Internet application 60, a streaming content application 62, and an enterprise resource planning (ERP) application 64.

As previously alluded to, the monitoring module monitors utilization parametrics that are indicative of the user's utilization of applications. The utilization parametrics are stored in the history log 49 and the guidelines 50, which may vary between applications, indicate which utilization parametrics and applications are to be monitored. For example, with respect to the Internet application 58 and browsing the world wide web, the guidelines 50 may indicate that the monitoring module 48 monitor parametrics relative to the (i) the number of permitted minutes/week, (ii) the number of minutes already consumed this week, (iii) the monitored and restricted start and end times (i.e., unrestricted Internet access may be permitted during certain periods of the day), (iv) the website destinations of the application, (v) the consumed time, (vi) the remaining time, (vii) the consumed bandwidth, and (viii) the remaining bandwidth. Collectively, the consumed bandwidth and the remaining bandwidth may be referred to as the amount of authorized bandwidth. The guidelines 50 may further indicate that if the user exceeds the permitted time during the monitored period, the monitoring module 48 may notify the user and request that the user terminate the Internet application 60. If the user fails to terminate the Internet application 60, then a violation notification may be sent to the processing module. In one implementation, certain time periods (by way of further examples: individuals with respect to IM applications, websites with respect to browsers) are considered un-metered and are monitored by the monitoring module 48, but not charged against the user's permitted Internet time.

By way of another example, the guidelines 50 may indicate that the IM application 56 should be monitored with respect to (i) the number of IM sessions permitted each day, week, month, etc. (ii) the number of IMs sent and received each week, (iii) the amount of time spent using the IM application 56, (iv) the individuals contacted by the IM application 56, and (v) the number of individuals contacted by the IM application 56. The guidelines 50 may indicate that if the user violates any of the guidelines, then monitoring module 48 notifies the user. Further, if the user fails to terminate the violating activities, then the monitoring module 48 may notify the processing module which, in turn, may notify a supervisor and/or another designated individual.

By way of further example, the guidelines 50 may indicate that the word processing application 52 requires monitoring with respect to utilization parametrics including (i) the number of keystrokes, (ii) the number of pages created, (iii) the number of documents created, (iv) the amount of time spent interacting with the word processing application 52, and (v) the amount of time remaining to interact with the word processing application 52. The utilization parametrics for the amount of time spent and the amount of time remaining may collectively be refereed to as the amount of authorized time. In one embodiment, regardless of whether or not the user violates the guidelines, the monitoring module does not block the user's request. In this respect, the systems and methods presented herein do not act as filter. Rather, as will be described in more detail hereinbelow, the systems and methods presented herein rely on the indications provided to the user by the meters and reports generated to create accountability that positively impacts behavior and results in increased human performance.

The kernel space 44 provides the layer of an operating system that contains the system-level commands, such as device drivers, memory management routines and system calls, hidden from the application space 42 that are utilized to control the hardware space 46. An application programing interface (API) 66 provides the set of standard interrupts, calls, and data formats, collectively commonly referred to as “hooks,” that the applications 52-64 use to initiate contact with the underlying kernel space 44 and hardware space 46. The Internet application 60, the IM application 56, and the word processing application 52 as well as the other applications discussed in FIG. 2 permit many of their function calls to the API 66 to be monitored by the monitoring module 48. More particularly, the monitoring module 48 monitors the function calls that are related to the utilization parametrics to determine how each application 52-64 is being utilized.

The hardware space 46 includes the actual physical computing machinery. For example, if platform 40 is a computer or notebook computer, the physical computing machinery may include components such as a liquid crystal display (LCD) panels, video adapters, integrated drive electronics (IDEs), CD-ROMs, and hard disk controllers, for example. As depicted, the hardware space 46 includes universal serial bus (USB) interfaces 68, 70, and 72 which allow multiple peripheral devices in a daisy-chain or star topology to be attached through a single interface to the platform 40. An IEEE 1394 or Firewire interface 74 is also included to provide a digital interface for consumer video electronics, hard disk drives, and related electronics. A Bluetooth interface 76 permits standardized wireless transmission between a wide variety of devices including personal computers, cordless telephones, personal digital assistants (PDAs), televisions, electronic game consoles, and MP3 players.

A wireless interface 78, which may be based on of the aforementioned IEEE 802.11, 802.11a, 802.11b (Wi-Fi), or 802.1G interfaces, provides a standardized networking architecture for a variety of devices that are similar to those listed with respect to the Bluetooth interface 76. A network interface card (NIC) 80 provides a physical and logical connection to a network, such as an intranet or an Internet. A keyboard interface 82 provides for a connection to a keyboard. An IEEE 1284 interface 84 provides for a connection to a printer.

The monitoring module 48 monitors utilization parametrics associated with the applications 52-64 and the hardware interfaces 68-84 to determine the utilization of an application. Additionally, the monitoring module 48 monitors utilization parametrics, such as keystrokes or websites, associated with the operating system which, in turn, is monitoring the hardware interfaces 68-84. By way of example, the monitoring module 48 monitors the Internet application 60 by monitoring the keystrokes inputted into keyboard interface 82, the history folder or file generated by the Internet application 60, the bandwidth consumption associated with the NIC 80 and the amount of time the Internet application 60 is in an active state, e.g., the monitoring module 48 does not consider the Internet application 60 to be active when it is minimized. The monitoring of the IM application 56 is similar to the monitoring of the Internet application 60. The monitoring module 48 monitors the word processing application 52 by monitoring the keystrokes inputted into keyboard interface 82, the number of pages generated by the word processing application 52, and the amount of time the word processing application 52 is in an active state.

The monitoring module 48 is equipped with additional features that prevent user abuse and ensure an accurate measurement of the time a user is utilizing an application. The monitoring module is operable to search the platform 40 for unauthorized files. For example, in the event that the user of the platform 40 attempts to circumvent the monitoring module 48 by installing unauthorized applications, the monitoring module 48 is operable to perform a periodic search of the files on the platform 40 to determine the presence of unauthorized file names and, in one embodiment, block the use of programs associated with these unauthorized file names. The monitoring module 48 may accomplish this by comparing a compiled list of file names associated with unauthorized applications to the applications installed in the application space 42. Additionally, the monitoring module can detect extended periods of application inactivity by analysis of the collected utilization parametrics. Responsive to the detected inactivity, the monitoring module may automatically minimize the application or temporarily halt the relevant utilization parametrics. By using either of these methodologies, user inactivity that may skew the visibility of the application utilization is ignored and not taken into consideration.

Accordingly, the monitoring module 48 tracks when the applications 52-64 are used and how each is being utilized in terms of utilization parametrics. The data collected by the monitoring module 48 relative to the utilization parametrics may be provided to the user and/or an administrator to yield insight into application utilization. With respect to the user, based upon the guidelines 50 for utilizing the particular application, the monitoring module 48 provides the user a substantially realtime, visible indication of the utilization. Preferably, the indication is achieved by way of a meter that is visible on a display associated with the platform 40. It should be appreciated, however, that the indication may also be audio. With respect to the administrator, the data may be forwarded via the NIC 80 to a processing module associated with a server so that an administrator may have visibility into the user's utilization of the application by viewing web-based reports, for example.

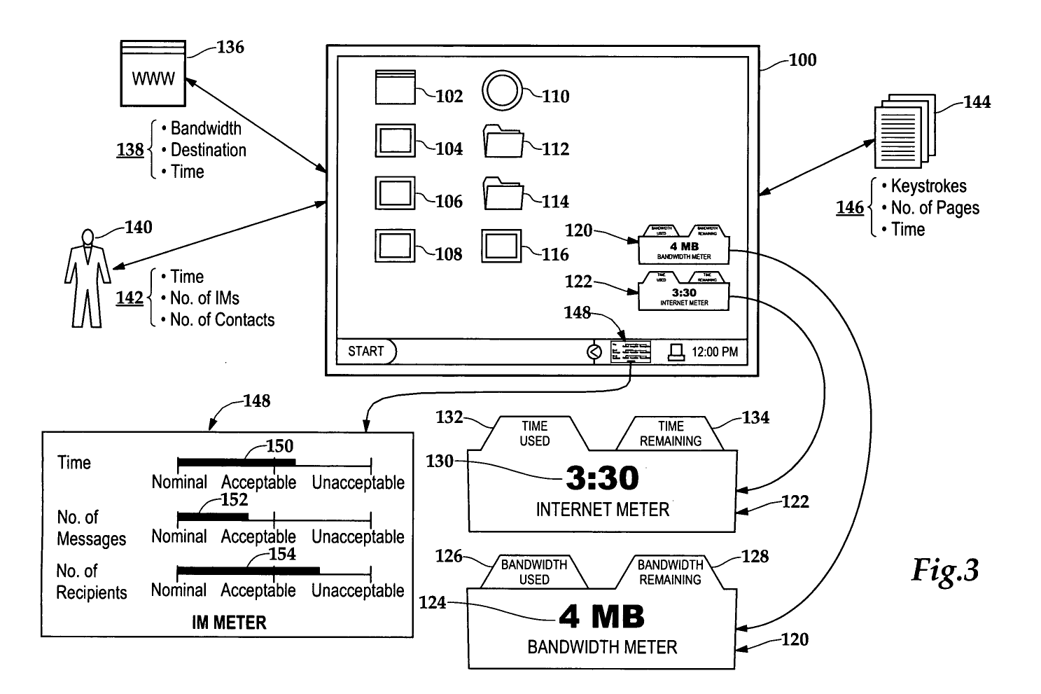

FIG. 3 depicts a schematic diagram of one operational embodiment of a display 100 of a computer platform having a monitoring module installed thereon. Icons 102 through 116 represent various applications running on the computer platform. The monitoring module provides a bandwidth meter 120 and an Internet meter 122 that are visible to the user on the display. In particular, the meters 120 and 122 provide an indication of application utilization to the user.

By way of example, the bandwidth meter 120 includes both a bandwidth used tab 126 and a bandwidth remaining tab 128 that provide the user with indications of the used and remaining bandwidth, respectively. As illustrated, the bandwidth remaining tab 128 is selected and, correspondingly, the bandwidth remaining 124, 4 MB, is shown. Similarly, the Internet meter 122 includes a time used tab 132 and a time remaining tab 134. The time used tab 132 is selected and the amount of time, 3 hours and 30 minutes, that the user has used accessing the Internet is displayed. The meters 120 and 122 may include other information as well. For example, meter 122 may include a listing by category (please see Table 1: Table 1: Categorization of Websites at paragraph 40 hereinbelow) of the most frequently visited websites.

The user is utilizing the Internet browser application 102 as indicated by the interactive www session icon 136. As discussed previously, the monitoring module monitors utilization parametrics 138 through the various applications or the hardware input interfaces such as keyboard inputs or mouse inputs, and the application state, for example. In particular, the bandwidth consumed, the destination or websites visited, and the time consumed are monitored. The monitoring module has the ability to monitor bandwidth usage by source application and by destination. An indication of the bandwidth consumed is provided to the user via meter 120. Each website that is visited is rated in accordance with a predefined list of categories, websites, and URLs as will be discussed in further detail hereinbelow. The time consumed is monitored and a corresponding indication of the time consumed is provided to the user by way of meter 122. In the illustrated embodiment, the data relative to the utilization parametrics 138 including the data relative to the bandwidth consumed, source information, destination information, and time consumed is forwarded to a processing module for further analysis.

The user is also utilizing an IM application 104 as indicated by the virtual contact session icon 140. The utilization of the IM application 104 is being monitored by way of utilization parametrics 140. More specifically, the amount of time consumed, the number of messages and the number of contacts communicated with are monitored by the monitoring module and then reported to the processing module for further analysis.

The word processing application 106 is also being utilized as represented by a word processing session icon 144. Utilization parametrics 146 which include keystrokes, number of pages produced, number of documents produced and amount of time consumed utilizing the word processing session 144 are monitored and data relative to the utilization parametrics 146 is transferred to the processing module. Although the meters 120 and 122 are depicted and described as only monitoring bandwidth and time consumed with respect to the Internet browser application 102, it should be appreciated that the meters 120 and 122 may provide any type of indication of application utilization to the user. By way of example, with respect to the IM application 104 and the IM session 140, a meter may display the amount of time spent using the IM application 104 or number of IMs sent during the IM session 140, for example. With respect to the word processing application 106 and the word processing session 144, a meter may display the average number of words per minute inputted or the average number of pages generated per hour, for example. Moreover, a meter may notify a user of a violation of the guidelines by presenting a visual indication with an explanation or an audio signal, for example.

It should be appreciated that the meters may have varied forms. For example, an IM meter 148 is located in the tray or pan of the desk top environment. The IM meter 148 indicates the amount of time, the number of messages, and the number of recipients with meters 150-154, respectively, that express each of these utilization parametrics in terms of a continuum having “nominal”, “acceptable”, and “unacceptable” designations. It should be further appreciated that any other applications, such as applications 52-64 of FIG. 2, may have meters associated therewith for providing substantially real-time indications of application utilization to the user. Further, the meters may be pop-up meters or meters that express or summarize a utilization parametric by presenting a small icon in a corner of the desktop environment for a temporary period of time. Additionally, meters may be integrated together to create a dashboard that provides a quick and easily accessible overview of the user's utilization. In particular, the dashboard may combine the data of meters 120, 122, and 148 into a single meter. It should be appreciated that alone, or integrated as a dashboard, meters 120, 122, and 148 provide a visible indication to the user of the utilization parametrics. Moreover, this visible indication may be updated in substantially realtime.

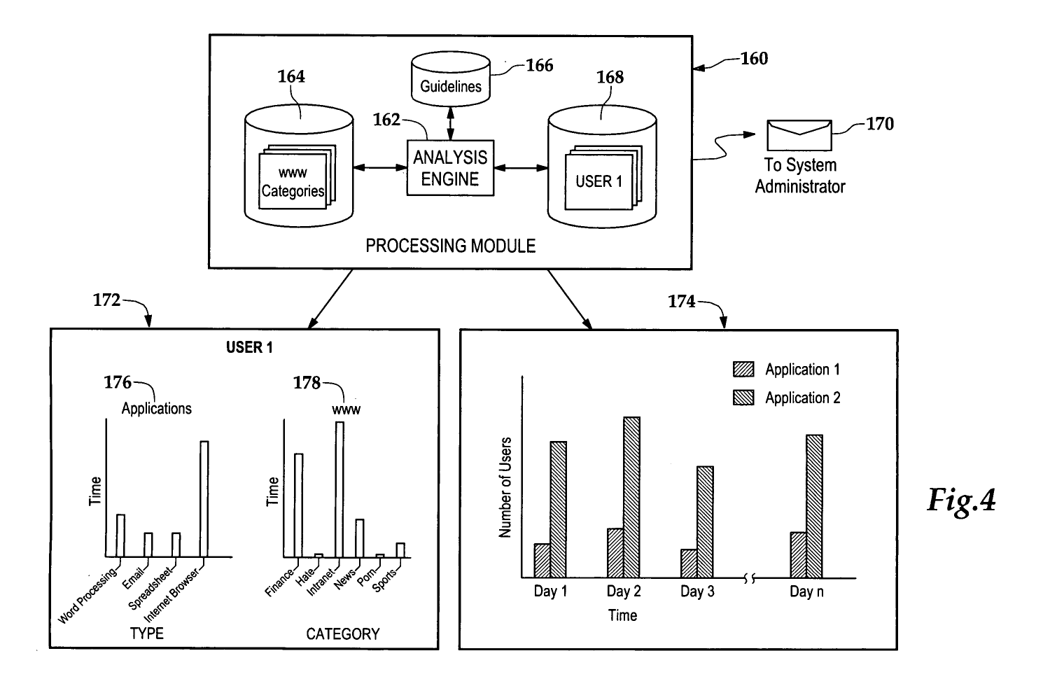

FIG. 4 depicts a schematic diagram of one embodiment of a processing module 160 generating reports in accordance with the teachings presented herein. The processing module 160 includes an analysis engine 162, a database 164 having a categorization of websites, a database 166 having guidelines, and a database 168 having user data. The analysis engine 162, which is the main processing element of the processing module 160, performs several functions with respect to each of the databases 164, 166, and 168 as well as the monitoring modules.

The database 164 provides an accessible archive of websites and their corresponding rating. The database 164 may be created from proprietary data, third-party data, or a combination thereof. By way of example, the following table illustrates the data that may be contained in the database 164.

TABLE 1
Categorization of Websites

| WEBSITE | CATEGORY |
|---|---|
| bestbuy.com | consumer |
| bloomberg.com | financial |
| cnn.com | news |
| espn.com | sports |
| sonypictures.com | entertainment |

It should be appreciated that additional categories of websites or alternative classifications are possible as well. For example, additional categories may include “hate” websites and pornographic websites. Additionally, it should be appreciated that the actual database will much larger. Further, in one embodiment, the processing module 160 and the guidelines 166 are associated with different computer platforms and communicate via a LAN or the Internet.

The guidelines 166 provide the aforementioned user and group based policies regarding the utilization of applications. Additionally, as previously discussed, the guidelines may be uniform for a group of users or specifically tailored on a user-by-user basis. The analysis engine 162 provides an interface, such as command line interface or a graphical user interface (GUI), to an administrator to configure the guidelines. In one embodiment, the interface is a web-based interface that permits the administrator to configure the guidelines from a computer that is remote with respect to the processing module 160.

The database 168 provides an accessible archive of each user's utilization of the applications being monitored. Each monitoring module transfers the data, e.g., history log 49 of FIG. 2, relative to the utilization parametrics from the user's computer to the processing module 160 wherein the analysis engine 162 stores the data in database 168. The monitoring modules may stream the data in substantially real-time, transfer the data after a predetermined period of time has lapsed, or transfer the data in response to an event such as the end of a business day or a violation of the guidelines. Once the data is transferred, the analysis engine 162 may be utilized by an administrator to view the raw data or generate a report (examples of which are presented hereinbelow). Moreover, it should be appreciated that the reports can be accessed and generated by users that have the proper permissions and network connection to the processing module.

With respect to database 164 and database 168, the websites a user has visited may be stored in the database 168 and these websites may be rated as the data is loaded into the database 168 from the monitoring modules. In another embodiment, the websites that a user has visited may be rated after a predetermined period of time in order to ensure that the database 164 of categories has the most up to date data.

Additionally, the processing module 160 can generate a exception notification 170 via an email or a page, for example, to notify a manager or employee supervisor of a user violation of the guidelines. In another embodiment, the exception notification 170 may be a regular update that is periodically sent to the administrator.

The report 172 displays the productivity of user 1 in table 176 and the Internet browsing activities of user 1 in table 178. Utilizing reports, such as the report 172, ensures that administrators and other IT management have the information necessary in order to gauge the usage levels of various applications, the amount of time the business spends running non-essential applications, and the amount of time the business spends utilizing essential applications, such as Internet browsers, for personal reasons, for example.

Reports, such as the report 172, generated from analysis of user activities, enable administrators or supervisors to design a group or user-specific gateway page based on the group's or user's application utilization. The gateway page may be a customized application presentation, such as a customized Internet browser presentation, that optimizes the selection of applications 102 through 116 that are presented on the user's computer platform. In another implementation, the gateway page may include a customized initial website or homepage, e.g., a gateway page, having quick links to the most valuable resources for a particular group's or user's profile. By way of example, the gateway page will contain the most frequently used pages and suggest links based on the utilization parametrics as well as the utilization parametrics of similarly situated groups users. The multiple levels of analysis and correlation from the individual level through the group, company, industry, and overall population provide opportunities to determine productive resources and usage practices. In an ASP model, with the user's and organization's permission, the gateway page provides a mechanism for targeted purchase offers, individualized advertisements, or marketing surveys, for example. In this model, the ASP acts as a broker between the user or organization and providers of goods and services. It should be appreciated that the technology described herein is not limited to ASP business models, but is amenable to other business models as well.

Moreover, reports such as the report 172 enable administrators to build user profiles that may be used for advertising purposes, to detect economic espionage, or to determine if the particular user posses a homeland security threat. Additionally, reports enable administrators or supervisors to understand trends in a user's behavior to understand how a user's behavior has changed over time. In one implementation, the reports are also available to each user so that each user can gain understanding into his or her behavior and take corrective action, if necessary.

The report 174 compares the utilization of two applications in a resource evaluation by displaying the number of users per day along a time line. By way of example, applications 1 and 2 may represent competing word processing applications. Reports, such as report 174, may be further utilized to determine if system applications have been upgraded. Additionally, the reports may be employed to determine the presence of exposures in software licencing compliance or determine the proper amount of licencing required.

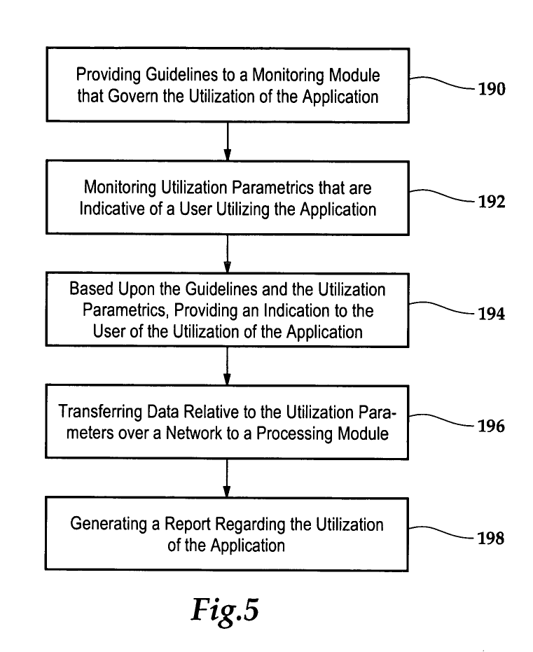

FIG. 5 depicts a flow chart of one embodiment of a method for monitoring application utilization. At block 190, guidelines are provided to a monitoring module in order to govern the utilization of the application. At block 192, utilization parametrics are monitored to determine if and how the user is utilizing the application. At block 194, based upon the guidelines and the utilization parametrics, an indication is provided to the user that notifies the user of the utilization of the application. At block 196, data relative to the utilization parametrics is transferred over a network, such as an intranet or the Internet, to a processing module. At block 198, the processing module generates a report regarding the utilization of the application. The reports provide accurate and timely information regarding the IT infrastructure. Thus, the information is available that is required to ensure the proper allocation of resources in order to maximize productivity and minimize costs. In particular, by utilizing the systems and methods discussed herein IT professionals are able to optimally deploy IT resources to those users who need them the most while avoiding the over purchasing of licenses.

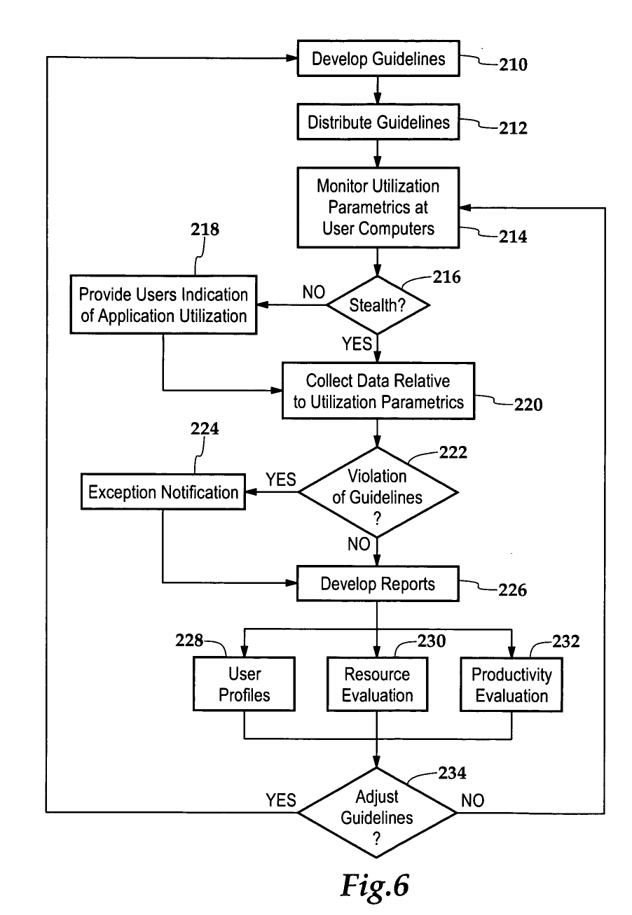

FIG. 6 depicts a flow chart of another embodiment of a method for monitoring application utilization. At block 210, guidelines are developed. The guidelines may differ from user to user or be uniform. At block 212, the guidelines are distributed to user computers. At block 214, utilization parametrics are monitored at the user computers in accordance with the guidelines.

As previously discussed, the system and methods presented herein may operate in a transparent mode or a stealth mode. In the transparent mode, the user is aware of the monitoring module and the guidelines in place. On the other hand, in the stealth mode, the user is unaware of the monitoring module or the guidelines. At decision block 216, if the monitoring modules are operating in a transparent mode, then the methodology advances to block 218 and then to block 220. At block 218, the user is provided an indication of the application utilization.

At block 220, data is collected relative to the utilization parametrics. At decision block 222, if the guidelines are being violated, then the user is notified at block 224 before the methodology advances to block 226. The user notification may be in the form of a warning or verification that ensures the user is intent on following through with the violating behavior. In one embodiment, regardless of whether or not the user violates the guidelines, the monitoring module does not block the user's request. In this respect, the systems and methods presented herein do not act as filter. Rather, the systems and methods presented herein rely on the indications provided to the user by the meters and reports generated to create accountability.

At block 226, reports are developed such as reports regarding user profiles (block 228), resource evaluation (block 230), and productivity evaluation (block 232). At block 234, based upon the reports generated, the guidelines of one or more users may be adjusted as indicated by the return arrow to block 210. If no guidelines need to be adjusted, then the methodology returns to block 214.

With respect to the stealth and transparent modes of operation illustrated in block 216, in one implementation, the methodology is first utilized in the stealth mode to determine the baseline behavior of group of users with respect to one or more applications. In the stealth mode of operation, the users are unaware of the monitoring agent. After developing a baseline profile of the application utilization, the methodology is utilized in the transparent mode to provide users feedback regarding their application utilization and to determine how users change their application utilization when they know that they are being monitored and being held accountable for their behavior.

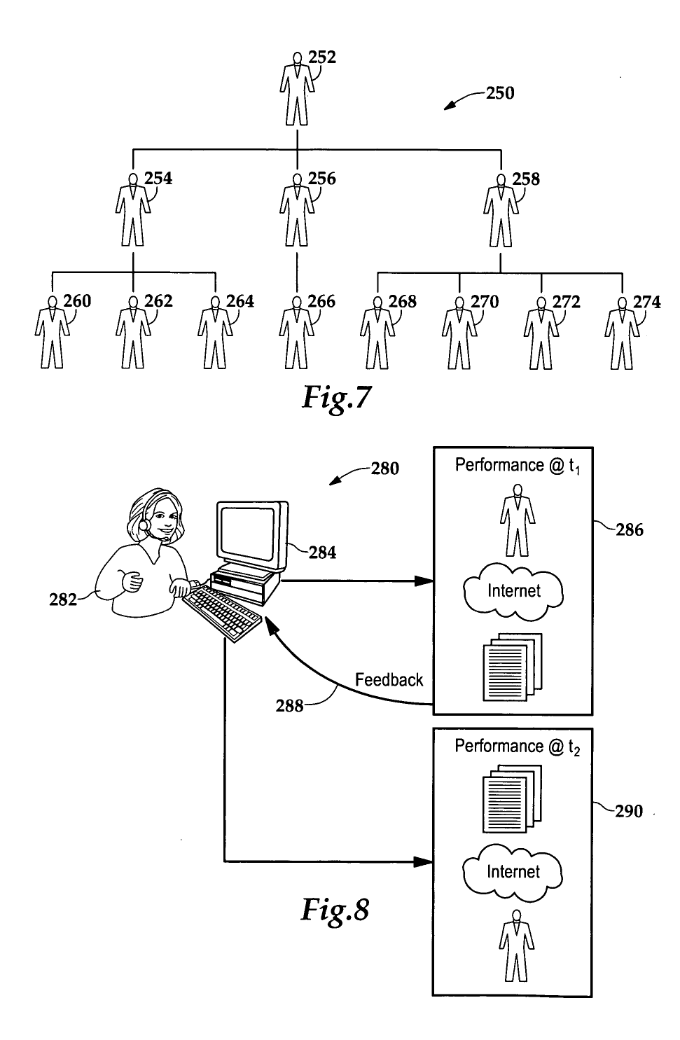

FIG. 7 depicts a corporate hierarchy 250 wherein one embodiment of a system for monitoring application utilization is being implemented. Employees 252-274 are arranged in a hierarchical corporate arrangement wherein, for example, employee 252 is in the highest supervisory position and oversees the work of employees 254-274. By way of further example, employee 254 is in a mid-level supervisory position and oversees employees 260-264, each of which have no supervisory role. The system for monitoring application utilization may be implemented to establish a hierarchy of rule making and an accountability that integrates with and leverages the benefits of the existing corporate hierarchy. In particular, each supervisor can make guidelines for those in his or her group. For example, employee 252 may make a set of general guidelines for employees 254-258 who, in turn, make more specific guidelines on a group or individual basis for their respective subordinates. With respect to accountability, each individual is accountable to themselves and his or her immediate supervisor. For example, employee 260 is accountable to himself and his supervisor, employee 254, who is accountable to his supervisor, employee 252. Although a traditional corporate hierarchy is depicted in FIG. 7, it should be understood that the systems and methods presented herein may be utilized with other management structures, such as a matrix management structure, for example.

FIG. 8 depicts a system 280 for monitoring application utilization. A user 282, an employee of a company, utilizes computer 284 to perform various tasks. At time t₁, the performance of user 282 is schematically illustrated in report 286 which was composed after analyzing various utilization parametrics associated with the behavior of user 282. The report 286 indicates how user 282 is spending her time in terms of a ranking and placement of icons that indicate user 282 is spending the most time on IM applications followed by Internet applications and, lastly, word processing applications.

The report 286 provides the user 282 with feedback 288 regarding her application utilization. The feedback 288, which is the result of analysis of the utilization parametrics, provides the user 282 with a documented review and visibility into the behavior of the user 282. Based upon feedback 288, user 282 corrects her behavior as illustrated by a report 290 which iconically depicts the behavior of user 282 at a later time, t₂. As depicted in the report 290, word processing applications receive the most attention from the user and IM applications receive the least time.

While this invention has been described with reference to illustrative embodiments, this description is not intended to be construed in a limiting sense. Various modifications and combinations of the illustrative embodiments as well as other embodiments of the invention, will be apparent to persons skilled in the art upon reference to the description. It is, therefore, intended that the appended claims encompass any such modifications or embodiments.

1. A system for monitoring utilization of an application, the system comprising:
a first computer operable to be connected to a network, the computer having the application installed thereon;
a monitoring module associated with the first computer, the monitoring module being operable to monitor a utilization parametric indicative of a user utilizing the application;
guidelines associated with the monitoring module, the guidelines governing the utilization of the application such that, based upon the guidelines, the monitoring module provides an indication to the user of the utilization of the application;
a second computer operable to be connected to the network; and
a processing module associated with the second computer, the processing module being operable to generate, based upon the utilization parametric, a report relative to the utilization of the application,
wherein the monitoring module transfers data relative to the utilization parametric over the network.

2. The system as recited in claim 1, wherein the monitoring module provides a substantially realtime, visible indication to the user of the utilization of the application.

3. The system as recited in claim 1, wherein the application is selected from the group consisting of word processing applications, spreadsheet applications, instant messaging applications, email applications, Internet browser applications, streaming content applications, and enterprise resource planning applications.

4. The system as recited in claim 1, wherein the utilization parametric is selected from the group consisting of bandwidth utilized, time utilized, source, destination, number of messages, number of contacts, keystrokes, number of pages generated, and number of documents generated.

5. The system as recited in claim 1, wherein the report is selected from the group consisting of user profile reports, resource evaluation reports, productivity evaluation reports, and trending reports.

6. A system for monitoring utilization, the system comprising:
a computer having a plurality of applications installed thereon; and
a monitoring module associated with the computer, the monitoring module being operable to monitor a plurality of utilization parametrics to determine the utilization of the plurality of applications by a user.

7. The system as recited in claim 6, wherein the monitoring module provides a substantially realtime, visible indication of the utilization of the applications by the user.

8. The system as recited in claim 6, wherein the plurality of applications are selected from the group consisting of word processing applications, spreadsheet applications, instant messaging applications, email applications, Internet browser applications, streaming content applications, and enterprise resource planning applications.

9. The system as recited in claim 6, wherein the plurality of utilization parametrics are selected from the group consisting of bandwidth utilized, time utilized, source, destination, number of messages, number of contacts, keystrokes, number of pages generated, and number of documents generated.

10. A system for monitoring utilization of an application, the system comprising:
a computer having the application installed thereon;
a monitoring module associated with the computer, the monitoring module being operable to monitor a utilization parametric indicative of a user utilizing the application; and
guidelines associated with the monitoring module, the guidelines governing the utilization of the application,
wherein the monitoring module, based upon the guidelines and the utilization parametric, provides an indication to the user of the utilization of the application.

11. The system as recited in claim 10, wherein the monitoring module provides a substantially realtime, visible indication to the user of the utilization of the application.

12. The system as recited in claim 10, wherein the application is selected from the group consisting of word processing applications, spreadsheet applications, instant messaging applications, email applications, Internet browser applications, streaming content applications, and enterprise resource planning applications.

13. The system as recited in claim 10, wherein the utilization parametric is selected from the group consisting of bandwidth utilized, time utilized, source, destination, number of messages, number of contacts, keystrokes, number of pages generated, and number of documents generated.

14. The system as recited in claim 10, wherein the guidelines comprise the amount of time the application may be utilized.

15. The system as recited in claim 10, wherein the guidelines comprise the amount of bandwidth that the application may consume.

16. The system as recited in claim 10, wherein the indication comprises a meter that displays the amount of authorized time the user has relative to the application.

17. The system as recited in claim 10, wherein the indication comprises a meter that displays the amount of authorized bandwidth the user has relative to the application.

18. A system for monitoring utilization of an application, the system comprising:
a first computer operable to be connected to a network, the computer having the application installed thereon;
a monitoring module associated with the first computer, the monitoring module being operable to monitor a utilization parametric indicative of a user utilizing the application;
a second computer operable to be connected to the network; and
a processing module associated with the second computer, the processing module being operable to generate, based upon the utilization parametric, a report relative to the utilization of the application,
wherein the monitoring module transfers data relative to the utilization parametric over the network.

19. The system as recited in claim 18, wherein the monitoring module provides a substantially realtime, visible indication of the utilization parametric.

20. The system as recited in claim 18, wherein the application is selected from the group consisting of word processing applications, spreadsheet applications, instant messaging applications, email applications, Internet browser applications, streaming content applications, and enterprise resource planning applications.

21. The system as recited in claim 18, wherein the utilization parametric is selected from the group consisting of bandwidth utilized, time utilized, source, destination, number of messages, number of contacts, keystrokes, number of pages generated, and number of documents generated.

22. The system as recited in claim 18, wherein the report is selected from the group consisting of user profile reports, resource evaluation reports, productivity evaluation reports, and trending reports.

23. A method for monitoring utilization of an application, the method comprising:
providing guidelines to a monitoring module, the guidelines governing the utilization of the application;
monitoring utilization parametrics that are indicative of a user utilizing the application;
transferring data relative to the utilization parametrics over a network to a processing module;
generating a report regarding the utilization of the application.

24. The method as recited in claim 23, further comprising, based upon the guidelines and the utilization parametrics, providing a substantially realtime, visible indication to the user of the utilization of the application.

25. The method as recited in claim 23, further comprising adjusting the guidelines based upon the report.

26. The method as recited in claim 23, wherein generating a report further comprises generating a user report regarding the utilization of the application by the user.

27. The method as recited in claim 23, wherein generating a report further comprises utilizing the data to generate a group report regarding the utilization of the application by multiple users.

28. The method as recited in claim 23, wherein generating a report further comprises generating a profile report.

29. The method as recited in claim 23, wherein generating a report further comprises generating a resource evaluation report.

30. The method as recited in claim 23, wherein generating a report further comprises generating a productivity evaluation report.

31. The method as recited in claim 23, wherein generating a report further comprises generating a trending report.

32. A system for monitoring utilization of an application, the method comprising:
means for providing guidelines to a monitoring module, the guidelines governing the utilization of the application;
means for monitoring utilization parametrics that are indicative of a user utilizing the application;
means for transferring data relative to the utilization parametrics over a network to a processing module;
means for generating a report regarding the utilization of the application.

33. The system as recited in claim 32, further comprising means for providing a substantially realtime, visible indication to the user of the utilization of the application based upon the guidelines and the utilization parametrics.

34. The system as recited in claim 32, further comprising means for adjusting the guidelines based upon the report.

35. The system as recited in claim 32, wherein the means for generating a report further comprises means for generating a user report regarding the utilization of the application by the user.

36. The system as recited in claim 32, wherein the means for generating a report further comprises means for utilizing the data to generate a group report regarding the utilization of the application by multiple users.

37. The system as recited in claim 32, wherein the means for generating a report further comprises means for generating a profile report.

38. The system as recited in claim 32, wherein the means for generating a report further comprises means for generating a resource evaluation report.

39. The system as recited in claim 32, wherein the means for generating a report further comprises means for generating a productivity evaluation report.

40. The system as recited in claim 32, wherein the means for generating a report further comprises means for generating a trending report.
